(19) United States
(12) Patent Application Publication
(10) Pub. No.: US 2024/0355217 A1
(43) Pub. Date: Oct. 24, 2024

(54) COMPUTER IMPLEMENTED SOFTWARE AND METHOD FOR A VIRTUAL REALITY EDUCATIONAL PLATFORM

(71) Applicant: Deven Drane, Plantation, FL (US)

(72) Inventor: Deven Drane, Plantation, FL (US)

(21) Appl. No.: 18/138,727

(22) Filed: Apr. 24, 2023

(51) Int. Cl. G09B 5/06; G06F 3/01; G06T 19/20; G09B 5/10; G09B 7/08

(52) U.S. Cl. CPC G09B 5/065; G06F 3/012; G06F 3/013; G06T 19/20; G09B 5/10; G09B 7/08; G06T 2219/2024

(57) ABSTRACT

The present invention comprises a computer implemented software and method for a virtual reality educational platform. The present invention incorporates existing lesson standards and lesson plans into a software generated platform that leverages virtual reality technology to create a real to life 3-D learning environment for grades K-12. The software of this present invention also integrates existing grading, attendance, and assessment software that unifies the teaching experience and the learning experience. Teachers are able to set the parameters for VR learning and students are able to access auto guided, manual guided or free roam lesson plans. Further students are able to utilize avatars to navigate the platform and have the ability to customize the avatar on an assessment-based token or reward system. The present invention allows teachers to simulate a learning environment while allowing students to be immersed in a simulated lesson environment.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates generally to a 3-D virtual reality education platform for grades K-12.

### BACKGROUND

There are many online learning platforms utilized by various schools, ranging from K-12 through the tertiary level. The existing online educational platforms or systems are two dimensional in design and function. These commonly used platforms or systems allow a student to view lesson plans, read or listen to prepared lesson plans, and submit classwork or homework through online means. This mode of learning lends to apathy among students, especially younger children prone to fidgeting or a population of students with high attention deficit rating.

Most students are familiar with gaming, which now includes three-dimensional (3-D) graphics and virtual reality (VR) technology. The high-level graphics and VR options are conducive to engaging gamers of all age groups who get locked into the real to life 3-D interactions with gaming characters and avatars. Presently, existing educational platforms or systems have not incorporated or leveraged 3-D VR technologies for learning or educational modalities.

### SUMMARY OF INVENTION

The present invention is a new and improved way to create innovative and hands on learning for grades K-12 across the globe by leveraging virtual reality technology. This invention combines standards and lesson plans with virtual reality (VR) technology to create a true to life, 3-D learning experience for a diverse student body and across various grade levels, learning standards, and a multitude of subjects (e.g., math, science, literature, arts etc.). Existing learning standards, whether set by local, State, or Federal guidelines, are aligned with approved lesson plans. The present invention converts and adapts these lesson plans to a virtual reality platform for use in grades K-12, delivering a real to life 3-D learning experience to students. This virtual reality lesson platform allows students to have an in-depth lesson and personal interaction with the topic or subject being taught. Students are physically and mentally engaged in the lesson and are given the opportunity to experience a new approach to educational instruction on a whole.

In addition to the unique student experience, the present invention will also provide teachers with the ability to interface with students and the lesson plan in real-time and 3-D. The present invention provides an interface where teachers are able to incorporate student rosters, attendance software, grading software, testing software, and similar tools used in the normal course of conducting a class and delivering a lesson plan. With the present invention, teachers will have a different login page and screen than students, which will enable teachers to oversee the student's virtual reality experience. The VR educational platform of this present invention allows teachers to narrate lessons, monitor student activities, as well as guide students through the various virtual reality lessons, without the teacher donning the virtual reality gear such as VR headsets and goggles. With the present invention, teachers have the ability to create virtual lesson tours that students can enjoy independently or free roam/explore.

Overall, the present invention provides a real to life 3-D experience that results in greater student engagement, absorption of educational material, and productive mental stimulation. The present invention seeks to bring to the educational space the same enthusiasm and long-term engagement experienced in the gaming space.

### BRIEF DESCRIPTION OF THE DRAWINGS

FIG. 1 illustrates the computer and hardware components used to implement the present invention;

FIG. 2A is a flow chart illustrating the steps for a teacher to access the software of the present invention;

FIG. 2B is a flow chart illustrating the steps for a student to access the software of the present invention;

FIG. 3 is a flow chart illustrating the steps for navigating the virtual reality platform of the present invention;

FIG. 4 is a flow chart illustrating the steps for navigating a virtual reality lesson environment generated by the present invention; and

FIG. 5 is a flow chart illustrating the steps for customizing an avatar within the virtual reality platform of the present invention.

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

In this specification, any reference to “Orb1” or “Orb One” should be construed as a reference the present invention in general, or more particularly to its software component.

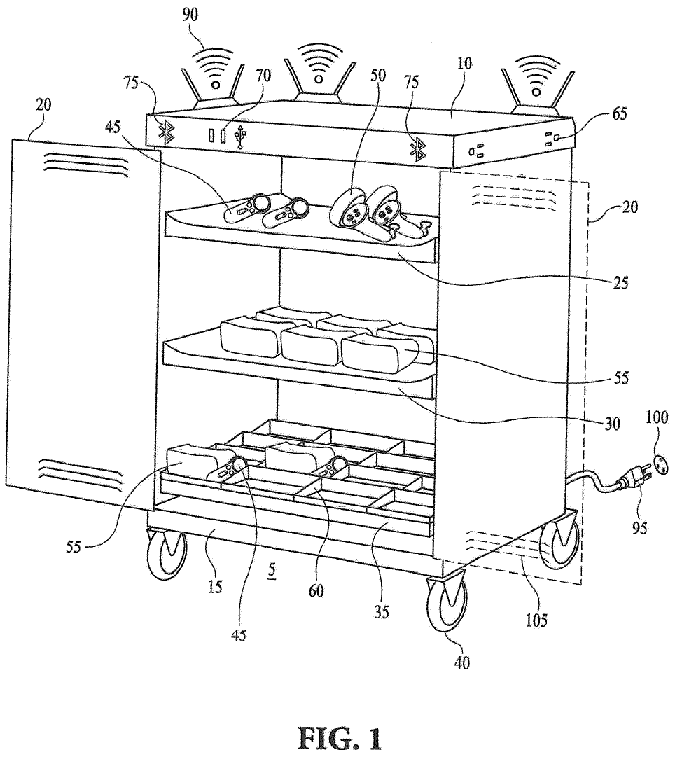

The present invention is a software application that combines existing educational standards and lesson plans with virtual reality technology (VR) to create a 3-D learning environment for students, which is controlled and operated by educators. As shown in FIG. 1, this invention is implemented by a self-contained and self-subsisting computer cart 5 comprising a top portion 10 which houses the computer and its components (motherboard, processor, fan etc.); a bottom portion 15 which houses a power source such as rechargeable batteries; two hinged doors 20 on opposite sides of the cart 5; interior shelves 25, 30, 35; and four wheels 40 for ease of movement and transport of the cart 5. The computer housed in the top portion 10 of the cart 5 has the capacity, memory, RAM, and processor to run or implement the software application that is the present invention, in addition to the graphics required for 3-D and VR digital relay. The interior shelves 25, 30, 35 of the cart 5 store the VR accessories, including controllers 45, 50 and VR goggles 55 and also serve as charging stations for the VR accessories. These VR accessories 45, 50 may be housed separately on an interior shelf 25, 30 or housed together on an interior shelves 35 in built-in compartments 60. The cart 5 also includes multiple power supply sources, whether traditional power outlets 65 or USB 70 for charging other accessories or electronics. The cart 5 includes built-in Bluetooth capability 75, Wi-fi connectivity 80, 85, 90. The power source 15 for the cart 5 may be rechargeable by way of an external power source or by way of a plug 95 and socket 100 connection to a wall outlet. Whether the cart 5 is in use or storing the VR accessories, the two hinged doors 20 may be closed and the self-contained cart 5 remains properly vented by way of the vents 105 located on the top and bottom of each door 20.

The present invention is a VR learning software 110 that is installed into a computer 10 which is connected to a power source 15 and internet network 80,85, 90, utilizing VR accessories 45, 50, 55 which are connected through wireless means 75 to create a digital relay from the computer 10 to the VR goggles 55 and the VR controllers 50, 55 to generate a 3-D VR learning platform or system. A User accesses the VR learning software 110 utilizing the VR goggles 55 and the VR controllers 45 or 50. The User utilizes the wireless VR controllers 45 or 50 to navigate the login process in which the VR goggles 55 provide a virtual viewer or virtual screen for visualizing the login input. A User may also access the VR learning platform using a laptop or desktop computer. A User may be a student, teacher, or administrator. Without being limiting, in describing this invention, a teacher or administer is preferably using a laptop to access the VR learning platform and a student is preferably using the VR accessories 45, 50, 55. For purposes of clarity, a student will be referred to as a Student User (SE), a teacher will be referred to as a Teacher User (TE), and an administrator will be referred to as an Administrative User (AE).

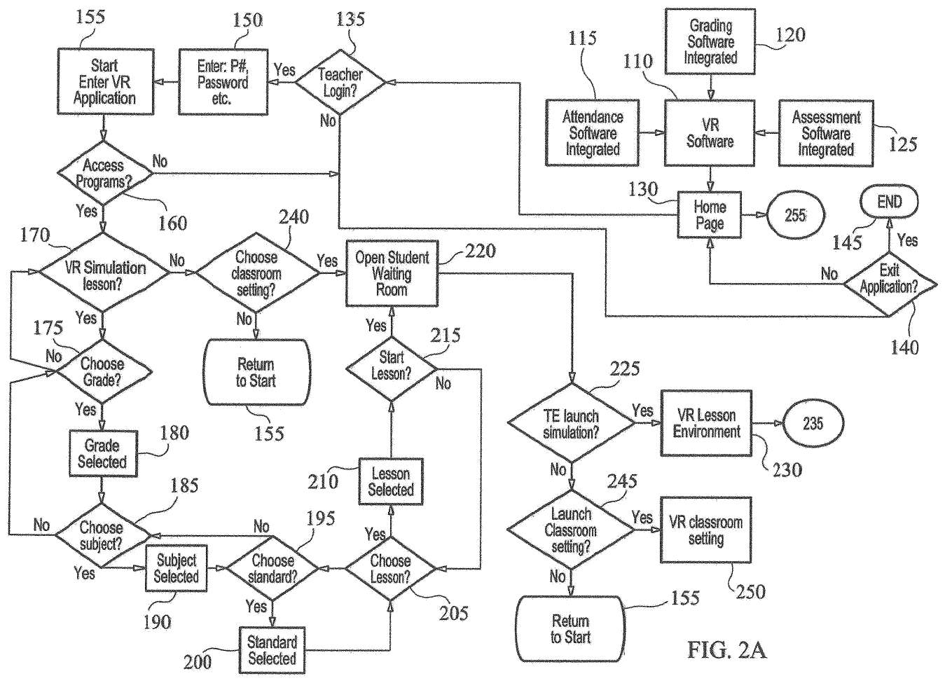

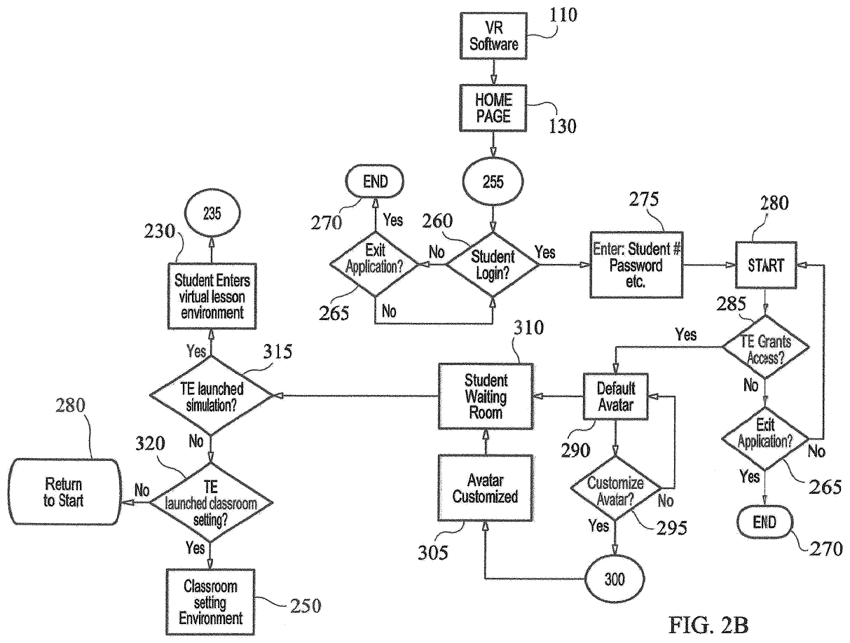

As shown in FIG. 2A, the VR Software 110 is integrated with educational software/programs, including but not limited to attendance 115, grading 120, and assessment software 125. A User accesses the VR platform and is directed to a Homepage 130 and is prompted to start the VR learning software application 110. The VR learning software application 110 has two or more paths depending on the User who is prompted to login by entering a username and password. A TE or SE may enter previously assigned login credentials or may be prompted to create new login credentials. The login credentials correspond to the specific login path and privileges associated with the User.

The present invention comprises a computer-implemented method for a virtual reality system to simulate a classroom environment, the method comprising: one or a plurality of computing resources, one or a plurality of processors, one or a plurality of virtual reality headsets with sensors, one or a plurality of virtual reality handheld units with sensors; one or a plurality of memory resources storing instructions that when executed by one or the plurality of processors cause the virtual reality system to simulate a classroom environment to: retrieve a user input via the virtual reality headsets and the virtual reality handheld units; wherein the user is one or a plurality of students and may include a teacher; and the user starts the virtual reality system to simulate the classroom environment.

The present invention comprises the computer-implemented method for a virtual reality system to simulate a classroom environment described herein wherein the virtual reality system to simulate the classroom environment accesses the sensor data through an application programming interface provided by the virtual reality system.

The present invention comprises the computer-implemented method for a virtual reality system to simulate a classroom environment described herein wherein the sensor of the virtual reality headset with sensors tracks a head position and a line of vision direction of the user and provides the head position and the line of vision direction to the application programming interface provided by the virtual reality system.

The present invention comprises the computer-implemented method for a virtual reality system to simulate a classroom environment, described herein, wherein the sensor of the virtual reality handheld units with sensors tracks a hand and a body position and a direction of motion of the user and provides the hand and the body position and the direction of motion to the application programming interface provided by the virtual reality system.

The present invention comprises the computer-implemented method for a virtual reality system to simulate a classroom environment described herein wherein the virtual reality system retrieves content from one or more databases over a network based on the sensor data and provides the retrieved content to the virtual reality application.

As Shown in FIG. 2A, a TE enters the VR software application 110 and is directed to the home page 130 and then is prompted to login 135. If the TE chooses not to login, then the TE is given the option to exit the application 140. If the TE chooses to exit the application 140 then the TE is directed to end the session 145. However, if the TE chooses not to exit the application 140 then the TE is returned to the VR software application 110 home page 130 in order to restart the login process 135. If the TE chooses to login 135, then the TE is prompted to enter previously assigned login credentials 150 and is then prompted to Start or Enter VR Application 155. Once the TE enters the VR application 155, the TE is prompted to access programs 160. If the TE chooses not to access programs 160 then the TE is prompted to exit the application 140 which if yes is selected, then the session ends 145 but if no is selected then the TE is returned to the VR software application 110 home page 130 in order to restart the login process. If the TE decides to access programs 160 then the TE is prompted to initiate a VR Simulation lesson 170, and if yes is selected, then the TE is prompted to choose a grade level (7^{th}, 8^{th}, 9^{th} etc.) 175. If the TE does not select a grade level, then the program returns to previous prompt 170, again giving the TE the option to run a VR Simulation lesson 170 and waits for the TE to input an option. However, if the TE selects a grade level 180, then the TE is then prompted to select a lesson subject 185 (e.g. math, English, science etc.) corresponding to the selected grade level 180. If the TE does not select a lesson subject, the program returns to the previous prompt 175 and awaits further action by the TE. If the TE selects a lesson subject 190, then the selected lesson subject is activated, and then the TE is prompted to choose a corresponding grade level standard 195. If the TE does not select the corresponding grade level standard 195, the program returns to the previous prompt 185 and awaits further action by the TE. However, if the TE selects the corresponding grade level standard 200, the selected standard is activated, and then the TE is prompted to choose a lesson plan 205 corresponding to the selected and activated grade level 180, subject 185, and standard 200. If the TE does not select a lesson plan 205, the program returns to the previous prompt 195 and awaits further action by the TE. If the TE selects a corresponding lesson plan 210, the lesson plan is activated, and then the TE is prompted to start the lesson 215. If the TE does not start the lesson 215, then the program returns to the previous prompt 205 and awaits further action by the TE. If the TE chooses to start the activated lesson plan 215, the program opens a VR Student waiting room 220, and then the TE is prompted to launch VR lesson simulation 225. The VR Student waiting room is the location where students gather virtually prior to the TE launching the VR lesson simulation. If the TE launches the VR lesson simulation, then a VR lesson environment 230 is generated, and students will be able to enter 235.

As shown in FIG. 2A, alternatively, after entering a username and password 150 and logging into the VR learning software application 155, and choosing to access programs 160, and then being prompted to run VR Simulation lesson 170, the TE may choose not to run a VR lesson simulation. In this instance, when prompted to initiate a virtual simulation 170 the TE has the option to choose no and will then be prompted to choose a virtual classroom setting 240. This virtual classroom setting is not tied to a grade 175, subject 190, or standard 200. If the TE does not choose to run a virtual classroom setting, then the program returns to the Start 155 position and awaits further input/action by the TE. However, if the TE does choose a virtual classroom setting, then the program opens the VR Student waiting room 220, and once all the students enter the waiting room, the TE is prompted to launch VR lesson simulation session 225. In this alternative, the TE selects not to launch a VR lesson simulation session and is prompted whether to launch a classroom setting 245, and if the TE chooses yes, then a virtual classroom setting is launched 250 and students can enter the virtual classroom setting environment 250. If the TE decides not to launch a VR classroom setting, then the program returns to the Start position 155 and awaits further input/action by the TE. The VR classroom setting environment 250 provides a virtual backdrop or environment for students to engage in activities, including watching a movie, discussing current events, checking in on student's mental health, or other activity not specifically tied to a subject, standard, or lesson plan.

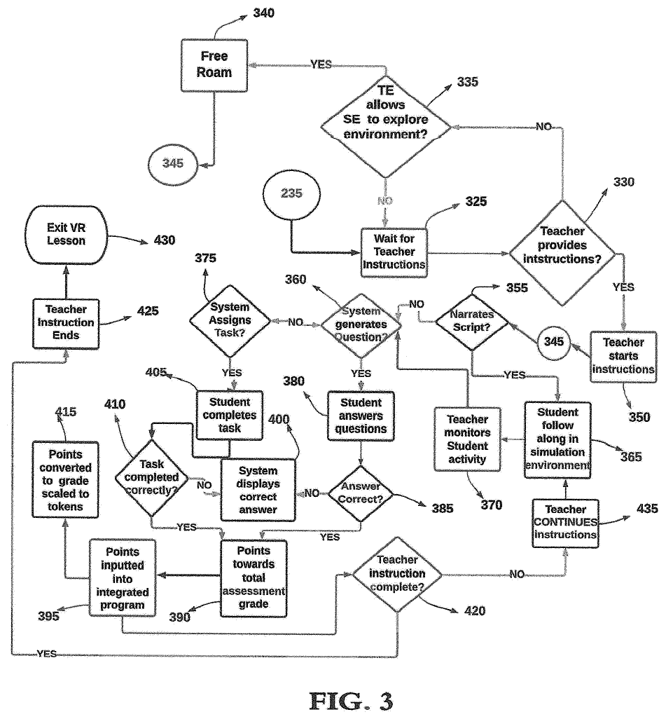

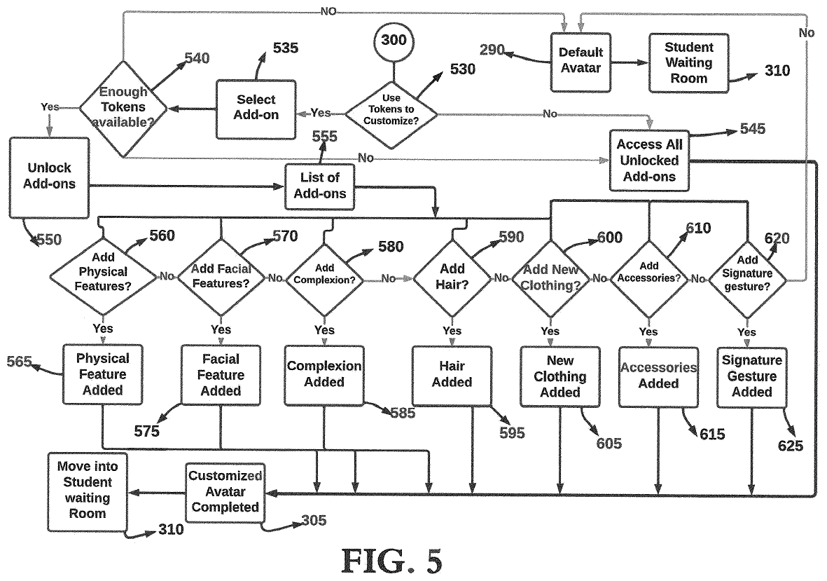

As shown in FIG. 2B when the User is a student, the SE accesses the VR application 120 using the VR goggles 55 and controllers 45, 50 and is directed to the home page 130 in order to log into the program 255. The SE is prompted to log into the program 260 and if the SE chooses to login, then the SE must enter a previously assigned or newly created username and password 275. If the student does not enter the correct login credentials or chooses not to log into the program, then the system prompts the SE to select whether to exit the application 265. If the SE chooses to exit the application, then the program ends 270. If the SE chooses not to exit the application, the program returns the SE to the Start position 280 to determine whether a TE has granted the SE access 285 to the program. If the TE did not grant access, then the SE is prompted whether to exit the application 265 and if the SE choose yes, then session ends 270. However, if the SE chooses not to exit application 265, then the SE is looped back to Start 280 and the program runs a continuous check whether the TE has granted access. Once access is granted, the SE is automatically assigned a default avatar 290 for moving about/navigating the VR environment. The avatar is a representation of the student within the VR simulation application. The SE is then prompted with the option to customize 295 the default avatar. If the SE chooses not to customize or is otherwise not able to customize the default avatar, then the SE is returned to the default avatar 290 and is automatically moved into the VR Student waiting room 310, only if already opened by the teacher. However, if the SE chooses to customize the default avatar 300, then the SE is able to add features, including but not limited to skin color, eye color, facial features, height, hair style, clothing, body type, gender, etc., as shown in FIG. 5. The addition of these features requires tokens which are earned based on academic performance, as shown in FIG. 3. Once an avatar is customized 305, the student is automatically moved into the VR Student waiting room 310, only if already opened by the teacher.

As shown in FIG. 2B, once all the students are moved into the VR Student waiting room 310, the program determines whether the TE has launched a VR simulation lesson plan 315. If the TE has launched a VR simulation lesson plan, then the SE enters the virtual simulation lesson environment 230 and await the TE's instructions and guidance through the lesson 235. If the TE has not launched a VR simulation lesson plan, then the program determines whether the TE has launched a virtual classroom setting 320. If the TE has launched a virtual classroom setting, then the SE enters the virtual classroom setting environment 250, and the TE's previously selected activity begins for the SE's participation. In the virtual classroom setting environment 250, students experience the environment via their default 290 or customized avatar 305. If the program determines that the TE has not launched a virtual classroom setting, then the program returns the SE to the start position 280, where the TE has the control over students' access to the program 285. If after a continuous loop back check access is not granted, then the SE is prompted to exit the VR application 265 and the program ends 270. If access is granted, then the SE is able to start a new session as described above.

Further, the present invention comprises a computer-implemented method for a virtual reality system to simulate a classroom environment wherein the application programming interface comprises: the user determining a simulation condition; the simulation condition comprising the selection of a simulation lesson or a simulation classroom setting; and wherein the simulation lesson comprises a grade, a subject, a standard, and a lesson renders a simulation classroom setting; and the teacher launching the simulation classroom setting and the student awaiting teacher instructions; and the teacher providing the students with instructions for the simulation lesson; and the students receiving instructions from the teacher and engaging in the simulation lesson; and the students completing the simulation lesson and the teacher providing feedback.

As shown in FIG. 3, upon launching the VR simulation lesson environment 235 where students await a TE's instructions 325, the TE is prompted to provide instructions 330. If the TE chooses not to provide instructions 330, then the TE is prompted whether to allow students to independently explore the VR simulation lesson environment 335. If the TE chooses to allow the students to explore the environment independently 335, then the students are able to free roam 340 in the virtual lesson environment 230 for a pre-selected lesson 345 while being monitored by the TE. This opportunity to free roam may include testing out the abilities and limitations of the student configured 305 or defaulted avatar 290. In the free roam option 340, the SE is not being guided or instructed by the TE or the program. If the teacher chooses not to allow students to independently explore the VR simulation lesson environment 335, then the program returns students to wait for teacher instructions 325. If the teacher chooses to start instructions, then the teacher initiates the instructions 350 for the lesson plan 345, and is prompted whether to narrate the script for the lesson plan 355. If the TE chooses not to narrate script 355, the program moves students to a system generated question prompt 360. However, if the TE chooses to narrate script 355, the students are able to follow along with narration 365 while experiencing the VR lesson environment 230. The TE narration includes guiding students through the various visuals and providing substantive material from the lesson plan, while students follow along in the simulation environment 365. Throughout the simulation lesson, the students are monitored by the TE 370.

As shown in FIG. 3, while going through the lesson plan and being monitored by the TE 370, students may be prompted to answer system generated questions 360 or complete system generated tasks 375. The program toggles between these prompts 360, 375 depending on the material to be covered in a lesson plan. This feature provides the students with a 3-D guided tour through the virtual environment with the ability to use sensory outputs to experience the lesson in 3-D. If the SE is prompted to answer a system generated question 360, makes an attempt to answer it 380, and answers the question correctly 385, then the system generates points that are tabulated as part of the total assessment grade 390. The points, assessment, and grading are compiled and generated 395 via the integrated attendance 115, assessment 125, and grading software 125. If the SE does not answer the system generated question correctly, then then the system displays the correct answer 400 with an explanation based on the material covered in the lesson. Alternatively, if the SE is prompted to complete a system generated task 375 or chooses not to attempt an answer to a system generated question 360, then the system assigns a task for completion 375. If the SE completes the system assigned task 405 and the task is completed correctly 410, then the system generates points that are tabulated as part of the total assessment grade for that SE 390. The points are inputted into an integrated grade book 395 to generate a grade which is tied to a token rewards program. The points are converted to a grade, and then tokens are generated based on a scaled grade schedule 415 (as shown in FIG. 5). If the SE does not complete the system assigned task correctly, then no points are generated, and the system displays the correct steps to completing the task 400. This question/answer and task/completion sequence is repeated throughout the lesson plan until the allotted time for the lesson plan expires or the TE chooses to end the instruction 420. If the TE chooses to end the instruction, then the teacher instruction ends 425 and exits the VR simulation lesson 430. The students also exit the VR simulation environment 430 when the TE exits the VR simulation application. If the TE chooses to continue the instruction 420, then the TE continues the instruction 435 and the program goes through the instruction process as described above.

Accordingly, the present invention comprises the computer-implemented method wherein the teacher feedback further comprises determining whether the simulation lesson generates questions; and calculating the number of questions the student answers correctly; and storing and recording points for the correctly answered questions. The computer-implemented method with teacher feedback further comprising: determining whether the simulation lesson generates tasks for the student; and calculating the number of tasks the student completes correctly; and storing and recording points for the correctly answered questions.

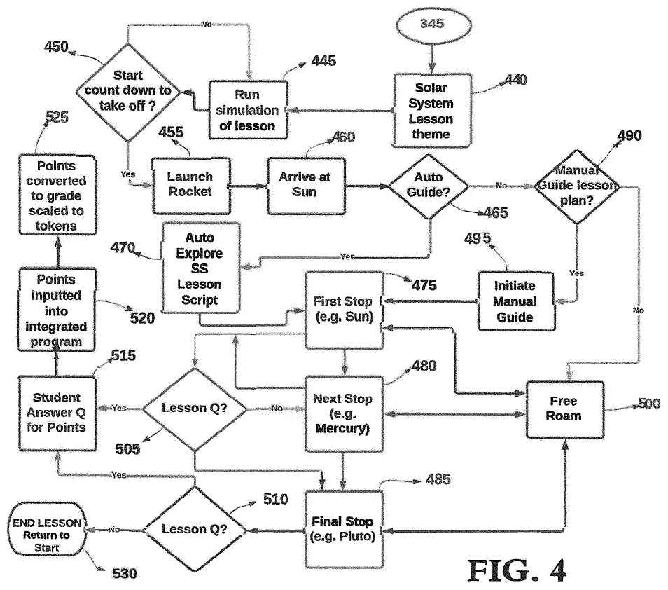

The present invention provides students with a 3-D VR simulation lesson in varying subjects, including but not limited to science, math, English, history, social studies, etc. Once a TE selects a lesson and launches the virtual lesson environment, as shown in FIG. 2A, FIG. 2B and FIG. 3, then the specific VR lesson simulation begins 345. FIG. 4 illustrates a VR simulation lesson plan on the solar system for grade six (6^{th} grade) 440. As shown in FIG. 4, the solar system lesson theme 440 corresponding to the lesson plan has been loaded and the TE begins to run the simulation for the solar system lesson plan 445. This particular lesson plan is centered around a rocket traveling from earth and making various stops within the solar system. According to this lesson plan, the TE is prompted to start the countdown to rocket launch 450. If the TE chooses not to start the count down, then the program returns to the previous station 445, prompting the TE to run simulation lesson. However, if the TE chooses to start the count down, then the rocket is launched 455, and the students are off on their journey through the solar system. The first stop in the solar system is the sun 460, and at this stage, the TE is prompted to select the option to initiate Auto Guide 465. Auto Guide is a setting that allows the program to run an automated lesson plan without any input or interference from the TE. If the TE selects Auto Guide 470, then the students are guided through scripted narration along each stop in the solar system lesson plan. As shown in FIG. 4, the virtual rocket makes stops at the sun 475 where students can explore the sun with an automated guided script then go to the next stop 480 and repeat the process until the final stop 485.

As shown in FIG. 4, alternatively, the TE can select to not initiate the Auto Guide 465, then the program prompts the TE select whether to initiate manual guide 490. If the TE chooses to initiate manual guide 490, then the program implements Manual Guide 495. Manual Guide is a setting that allows the student to control the navigation of the lesson through the solar system, starting with the first stop 475. As shown in FIG. 4, in Manual Guide mode 495, the SE controls the stops along the solar system lesson plan, including manually accessing the lesson script corresponding to each stop, until the SE reaches the final stop 485. This allows the SE to navigate the virtual lesson plan at a self-determined paced.

As another alternative, if the SE chooses not to select a Manual Guide 490, the SE can initiate a Free Roam mode 500 as shown in FIG. 4. The Free Roam 500 mode allows the SE to go through the solar system lesson not only at a self-determined pace, but also with self-determined order of stops within the solar system. Thus, the SE may start at the final stop 485 in the lesson plan or the second stop 480, creating an individual path through the solar system.

Regardless of whether the SE chooses the Auto Guide 465, Manual Guide 490, or Free Roam mode 500, one or more question(s) 505, 510 is/are generated at each stop 475, 480, 485 in the solar system lesson plan, as a means to reinforce learning and assess the material learned or absorbed by the SE. If a lesson question is generated 505, 510 and the student answers the question correctly 515, then points are awarded and inputted into an integrated grading program 520, which points are converted to a grade scaled to tokens 525. This process is repeated at each stop 475, 480, 485 in the lesson plan. If a lesson question is not generated or attempted by an SE, then the lesson ends 530. At which point, the TE and SE may exit the virtual simulation application.

Accordingly, the present invention comprises the computer-implemented method for a virtual reality system to simulate a classroom environment wherein the simulation lesson comprises: the selection of a manual guide more or an automatic guide mode; and wherein the manual guide mode allows the student to control how the simulation starts, stops, and results in the student navigating the simulation lesson at a self-determine pace.

With the present invention, a SE is able to customize 300 the default avatar 290 for purposes of experiencing and navigating the VR lesson environment 230. As shown in FIG. 5, if the SE chooses to customize 300 the default avatar 290, then the customizing process begins with a prompt to use tokens to customize avatar 530. If the SE decides to use tokens to customize the avatar, then the program moves the SE to select an Add-on 535. Add-ons include, but are not limited to physical features, facial features, complexion, hair, clothing, accessories, or a signature gesture. An SE requires tokens which are generated based on a scaled grade schedule. For purposes of this invention, and without being limiting, a scaled grade schedule is defined as the assignment of a finite number of tokens to a letter grade or increment of a letter, i.e., a number of tokens are generated for A, B, C, or D grade achieved. Before the SE can select an Add-on 535, the system is prompted to check whether the SE has generated enough tokens 540 to select an Add-on. If the SE does not have enough tokens, then SE is cycled to access previously unlocked Add-ons 535 or the default Avatar features 290. If the SE does not have enough token(s) to customize a default avatar, nor any previously unlocked Add-ons, then the SE maintains the default avatar 290, and moves to the student waiting room 310 (as shown in FIG. 2B). If the SE does have enough tokens, then the SE is able to unlock Add-ons 550 and can move to the list of available add-ons 555 and select the desired Add-ons for customization of the default avatar 290.

As shown in FIG. 5, the system prompts the SE to select a physical features Add-on 560, including but not limited to height, body type, size, body part proportion, other physical dimensions, as well as body markings such as tattoos. This list of physical features is not meant to be limiting, but rather illustrative of the variety of physical dimensions available to an SE who is customizing an avatar for use within the VR lesson environment. If one or more physical features Add-on is selected, then the SE is able to add the desired physical feature(s) 565 and complete the customization of the avatar 305. Once the avatar is customized, the SE moves to the student waiting room 310. However, if physical features Add-on is not selected, then the system prompts the SE to choose a Facial Features 570. If the SE chooses to add facial features 575, then these features are selected, including but not limited to eye color, eye shape, cheekbone, chin shape, nose shape, eyebrows, eyelash, mouth, smile, and/or dimples. This list of facial features is not meant to be limiting, but rather illustrative of the variety of features available to an SE who is configuring an avatar for use within the VR lesson environment. The SE is able to add the desired facial features and complete the customization of the avatar. Once the avatar is customized for facial features 305, the SE moves to the student waiting room 310. However, if facial features Add-ons are not selected, then the system prompts the SE to choose skin complexion Add-ons 580. If the SE chooses to add skin complexion 585, a selection is made from a wide swath of hues covering the spectrum from light to dark complexion or complexion with freckles or other natural markings. This list of complexion shading and marking is not meant to be limiting, but rather illustrative of the wide range of complexions available to an SE who is customizing an avatar for use within the VR lesson environment. However, if skin complexion is not selected, then the system prompts the SE to choose Hair 590. If the SE chooses to add Hair 595, a selection is made from a wide range of hair styles, hair color, hair length, hair texture (curly, wavy, straight, etc.), and hair accessories. This list of Hair categories is not meant to be limiting, but illustrative of the various Hair options available to an SE who is customizing an avatar for use within the VR lesson environment. Further, the SE is able to select from a long and expansive list of options across these categories, which is not enumerated herein, but is known to one of ordinary skill in the art of developing and customizing avatars for use in a VR or gaming environment. The SE is able to add the desired Hair and complete the customization of the avatar 305. Once the avatar is customized for hair, the SE moves to the student waiting room 310. However, if hair is not selected, then the system prompts the SE to add clothing 600, and if the SE chooses to add clothing 605, then these items are selected from a wide selection of styles, colors, fit, type, and/or texture. This list of clothing categories is not meant to be limiting, but illustrative of the various clothing options available to an SE who is customizing an avatar for use within the VR lesson environment. The SE is able to add the desired clothing 605 and complete the customization of the avatar 305. Once the avatar is customized for Clothing, the SE moves to the student waiting room 310. However, if clothing is not selected, then the system prompts the SE to add accessories 610, and if the SE chooses to add accessories 615, then these accessories are selected, including but not limited to watches, necklaces, rings, earrings, nose rings, wristlets, bracelets, handbags, cross body bags, man purses, and any other accessory known to one of ordinary skill in the art of gaming fashion. This list of accessories is not meant to be limiting, but rather illustrative of the variety of accessories available to an SE who is customizing an avatar for use within the VR lesson environment. However, if accessories are not selected as an Add-on, then the system prompts the SE to choose Signature Gestures 620. If the SE chooses to add Signature Gesture 625, a selection is made from a wide range of gestures, including but not limited to head movements, hand gestures, shoulder shrugs, facial gestures (e.g., wink, broad smile, scowl, etc.), and/or other gestures known to one of ordinary skill in the area of developing avatar gestures. This list of gestures is not meant to be limiting, but illustrative of the various gesture options available to an SE who is customizing an avatar for use within the VR lesson environment. The SE is able to add the desired gesture and complete the customization of the avatar 305. Once the avatar is customized for Signature Gestures, the SE moves to the student waiting room 310. However, if the SE chooses not to go through the Add-on process and does not select any of the available Add-ons, then the system relays the SE back to the default avatar 290, and the SE is moved into the student waiting room 310.

Accordingly, the present invention comprises the computer-implemented method for a virtual reality system to simulate a classroom environment wherein the student further comprises: an avatar; determining whether to further customize the avatar comprising; and wherein customizing the avatar comprises a physical feature, a facial feature, a complexion feature, a hair feature, a clothing feature, an accessory feature, a signature gesture feature; and when finished customizing the avatar a student is awaiting teacher instructions.

As various changes may be made in the above-described subject matter without departing from the scope and the spirit of the invention, it is intended that all subject matter contained in the above description, or shown in the accompanying drawings, will be interpreted as descriptive and illustrative, and not in a limiting sense.

### EQUIVALENTS

Those skilled in the art will recognize or be able to ascertain using no more than routine experimentation, many equivalents to the specific embodiments of the invention described herein. Such equivalents are intended to be encompassed by the claims.

What is claimed is:

1. A computer-implemented method for a virtual reality system to simulate a classroom environment, the method comprising:
one or a plurality of computing resources, one or a plurality of processors, one or a plurality of virtual reality headsets with sensors, one or a plurality of virtual reality handheld units with sensors;
one or a plurality of memory resources storing instructions that when executed by one or the plurality of processors cause the virtual reality system to simulate a classroom environment to:
retrieve a user input via the virtual reality headsets and the virtual reality handheld units;
wherein the user is one or a plurality of students and may include a teacher; and
the user starts the virtual reality system to simulate the classroom environment.

2. The computer-implemented method for a virtual reality system to simulate a classroom environment of claim 1 wherein the virtual reality system to simulate the classroom environment accesses the sensor data through an application programming interface provided by the virtual reality system.

3. The computer-implemented method for a virtual reality system to simulate a classroom environment of claim 1 wherein the sensor of the virtual reality headset with sensors tracks a head position and a line of vision direction of the user and provides the head position and the line of vision direction to the application programming interface provided by the virtual reality system.

4. The computer-implemented method for a virtual reality system to simulate a classroom environment of claim 1 wherein the sensor of the virtual reality handheld units with sensors tracks a hand and a body position and a direction of motion of the user and provides the hand and the body position and the direction of motion to the application programming interface provided by the virtual reality system.

5. The computer-implemented method for a virtual reality system to simulate a classroom environment of claim 1 wherein the virtual reality system retrieves content from one or more databases over a network based on the sensor data and provides the retrieved content to the virtual reality application.

6. The computer-implemented method for a virtual reality system to simulate a classroom environment of claim 1 further wherein the application programming interface comprising:
the user determining a simulation condition;
the simulation condition comprising the selection of a simulation lesson or a simulation classroom setting;
wherein the simulation lesson comprises a grade, a subject, a standard, and a lesson renders a the simulation classroom setting;
the teacher launching the simulation classroom setting and the student awaiting teacher instructions;
the teacher providing the students with instructions for the simulation lesson;
the students receiving instructions from the teacher and engaging in the simulation lesson;
the students completing the simulation lesson and the teacher providing feedback.

7. The computer-implemented method for a virtual reality system to simulate a classroom environment of claim 1 further wherein the simulation lesson comprising:
the selection of a manual guide more or an automatic guide mode;
wherein the manual guide mode allows the student to control how the simulation starts, stops, and results in the student navigating the simulation lesson at a self-determine pace.

8. The computer-implemented method for a virtual reality system to simulate a classroom environment of claim 1 further wherein the student further comprising:
an avatar;
determining whether to further customize the avatar comprising:
wherein customizing the avatar comprises a physical feature, a facial feature, a complexion feature, a hair feature, a clothing feature, an accessory feature, a signature gesture feature; and
when finished customizing the avatar a student is awaiting teacher instructions.

9. The computer-implemented method of claim 6 wherein the teacher feedback further comprising:
determining whether the simulation lesson generates questions;
calculating the number of questions the student answers correctly; and
storing and recording points for the correctly answered questions.

10. The computer-implemented method of claim 6 wherein the teacher feedback further comprising:
determining whether the simulation lesson generates tasks for the student;
calculating the number of tasks the student completes correctly; and
storing and recording points for the correctly answered questions.

11. A non-transitory computer-readable medium with instructions for a virtual reality system stored thereon that, responsive to execution by a processing device, cause the processing device to perform operations comprising:
retrieving from sensor data from a virtual reality headset and a virtual reality handheld unit, sensor data corresponding to a situational environment of a user; providing the sensor data to an application programming interface of a virtual reality application; the virtual reality application on a computing device managing utilization of computing resources and executing computing instructions based on the application programming interface;
the user determining a simulation condition;
the simulation condition comprising the selection of a simulation lesson or a simulation classroom setting;
wherein the simulation lesson comprises a grade, a subject, a standard, and a lesson renders a the simulation classroom setting;
the teacher launching the simulation classroom setting and the student awaiting teacher instructions;
the teacher providing the students with instructions for the simulation lesson;
the students receiving instructions from the teacher and engaging in the simulation lesson;
the students completing the simulation lesson and the teacher providing feedback.

12. A system comprising:
a memory with instructions stored thereon; and
a processing device, coupled to the memory, the processing device configured to access the memory and execute the instructions, wherein the instructions cause the processing device to perform operations comprising:
the user determining a simulation condition;
the simulation condition comprising the selection of a simulation lesson or a simulation classroom setting;
wherein the simulation lesson comprises a grade, a subject, a standard, and a lesson renders a the simulation classroom setting;
the teacher launching the simulation classroom setting and the student awaiting teacher instructions;
the teacher providing the students with instructions for the simulation lesson;
the students receiving instructions from the teacher and engaging in the simulation lesson;
the students completing the simulation lesson and the teacher providing feedback.
